(19) United States
(12) Patent Application Publication
(10) Pub. No.: US 2019/0164125 A1
(43) Pub. Date: May 30, 2019

(54) METHODS, SYSTEMS, AND PROGRAM PRODUCT FOR DELIVERING ITEMS TO USERS

(71) Applicant: International Business Machines Corporation, Armonk, NY (US)

(72) Inventors: Gregory J. Boss, Saginaw, MI (US); Cesar Augusto Rodriguez Bravo, San Rafael de Alajuela (CR); Jayashree Vaidyanathan, Cincinnati, OH (US)

(21) Appl. No.: 15/822,905

(22) Filed: Nov. 27, 2017

(51) Int. Cl. G06Q 10/08; G06Q 30/06; G06Q 50/28

(52) U.S. Cl. CPC G06Q 10/08345; G06Q 10/0835; G06Q 50/28; G06Q 10/087; G06Q 30/0601

(57) ABSTRACT

Methods, systems, and program products for delivering items to users are disclosed. The methods may include determining a location of a first user, where the first user purchased a first item stored at a first item location. The methods may also include generating a delivery itinerary including the first item to be delivered to the first user at the first user's location. Additionally, the methods may include identifying a second item, where the second item may be associated with a second user. Furthermore, the methods may include determining a second user's location, and comparing the first user's location with the second user's location. If the locations are the same, the delivery itinerary may be updated to include the first item to be delivered to the first user, and the second item to be delivered to the second user.

### TECHNICAL FIELD

The disclosure relates generally to item delivery, and more particularly to methods, systems, and program products for delivering items to users.

### BACKGROUND

More and more consumers are turning to websites, virtual stores, and online shopping, rather than physical stand-alone stores, to purchase items for personal and business purposes. That is, because of the ease in the ability to review all items with detailed descriptions and multiple photos, all-encompassing websites and/or virtual stores that include every item available (e.g., not those just in stock at the store), the accessibility on nearly all personal electronic devices anywhere in the world, and simple manner in which items may be purchased, consumers are able to get everything they need at the touch of a button. This is especially beneficial where consumers are able to receive their purchased items at no additional cost (e.g., shipping cost) when compared to the consumer actually going to a physical store and purchasing the items. Specifically, consumers may receive their purchased items with no shipping cost or with free delivery, which results in the items being shipped directly to the consumer at the same price and/or cost if the consumer visited the store and purchased the item in person.

However, not all online purchases have free shipping. The requirement to pay shipping cost may be determined and/or set by the manufacturer, supplier, retail store and/or delivery entity based on characteristics of the items being purchased via websites and/or virtual stores and delivered directly to consumers. For example, free shipping may or may not be available based on a minimum purchase price requirement, a location in which the item is being shipped to and/or from, or which day of the week the item is scheduled to be delivered. Because some purchase circumstances still require a shipping fee to be paid for delivery of the item, consumers may be hesitant to purchase certain items; especially where the items cost less than, as much as, or slightly more than the shipping cost itself. For example, a consumer may purchase small electronic components, such as resistors, transistors, relays and/or led lights, which may cost between $0.10 and $0.50, and may be manufactured in and shipped from China. However, because these items are manufactured in and shipped from China, a consumer in the United States purchasing these items may pay as much as $15.00 in shipping costs for items that may cost only a few dollars to actually purchase. As a result, a consumer may not purchase items as frequently as desired, if at all, because of the associated shipping costs. This in turn may result in manufacturers, suppliers, retail stores, and/or delivery entities losing multiple purchases and/or deliveries every day, which ultimately lowers revenue stream.

### SUMMARY

Aspects of the disclosure provide methods, systems, and program products for delivering items to users.

A first aspect discloses a method for aiding in a delivery of items to users. The method including: determining a location of a first user, the first user having purchased a first item stored at a first item location; generating a delivery itinerary for a future date, the delivery itinerary including the first item to be delivered to the first user at the location of the first user; identifying a second item distinct from the first item, the second item associated with a second user, distinct from the first user; determining a location of the second user; comparing the location of the first user with the location of the second user; and in response to determining the location of the first user is the same as the location of the second user, updating the delivery itinerary for the future date to include: the first item to be delivered to the first user at the location of the first user, and the second item to be delivered to the second user at the location of the second user.

A second aspect discloses a computer program product stored on a computer readable storage medium, which when executed by a computing system, aids in the delivery of items to users. The program product including: program code that determines a location of a first user, the first user having purchased a first item stored at a first item location; program code that generates a delivery itinerary for a future date, the delivery itinerary including the first item to be delivered to the first user at the location of the first user; program code that identifies a second item distinct from the first item, the second item associated with a second user, distinct from the first user; program code that determines a location of the second user; program code that compares the location of the first user with the location of the second user; and program code that updates the delivery itinerary for the future date in response to the program code determining the location of the first user is the same as the location of the second user, the updated delivery itinerary for the future date including: the first item to be delivered to the first user at the location of the first user, and the second item to be delivered to the second user at the location of the second user.

A third aspect discloses a computing system for aiding in a delivery of items to users. The computing system including: an identified item data module that: identifies a first item purchased by a first user; and identifies a second item associated with a second user; a user location data module that: determines a location of the first user; determines a location of the second user; and compares the location of the first user with the location of the second user; and determines if the location of the first user is the same as the location of the second user; and a delivery itinerary data module that: generates a delivery itinerary for a future data, the generated delivery itinerary including the first item to be delivered to the first user at the location of the first user; and updates the delivery itinerary for the future date in response to the user location data module determining that the location of the first user is the same as the location of the second user, the updated delivery itinerary including: the first item to be delivered to the first user at the location of the first user, and the second item to be delivered to the second user at the location of the second user.

The illustrative aspects of the present disclosure solve the problems herein described and/or other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow chart of an example processes for aiding in a delivery of items to users, according to embodiments.

FIG. 2 depicts a flow chart of example processes of identifying a second item associated with a second user, as shown in FIG. 1, according to embodiments.

FIG. 3 depicts a flow chart of an example processes for aiding in a delivery of items to users including determining of an item location of a second item, according to embodiments.

FIG. 4 depicts a flow chart of an example processes for aiding in a delivery of items to users including determining if a second user purchased a second item, according to embodiments.

FIG. 5 depicts a flow chart of an example processes for aiding in a delivery of items to users including determining if a second user purchased a second item, according to additional embodiments.

FIG. 6 depicts a flow chart of an example processes for aiding in a delivery of items to users including determining if a second user purchased a second item and determining if the second user paid a reduced shipping cost, according to embodiments.

FIG. 7 depicts a flow chart of an example processes for aiding in a delivery of items to users including determining if a third user purchased a third item, according to embodiments.

FIG. 8 depicts an environment include a plurality of items at an item location, and a plurality of users at a delivery location, according to embodiments.

FIG. 9 depicts an environment include a plurality of items at an item location, and a plurality of users at distinct delivery locations, according to embodiments.

FIG. 10 depicts an environment include a plurality of items at various item locations, and a plurality of users at a delivery location, according to embodiments.

FIG. 11 depicts an environment include a plurality of items at an item location, and a plurality of users at a delivery location, according to additional embodiments.

FIG. 12 depicts an environment include a plurality of items at an item location, and a plurality of users at distinct delivery locations, according to additional embodiments.

FIG. 13 depicts a schematic view of an electronic device configured to aid in a delivery of items to users, according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to item delivery, and more particularly to methods, systems, and program products for delivering items to users.

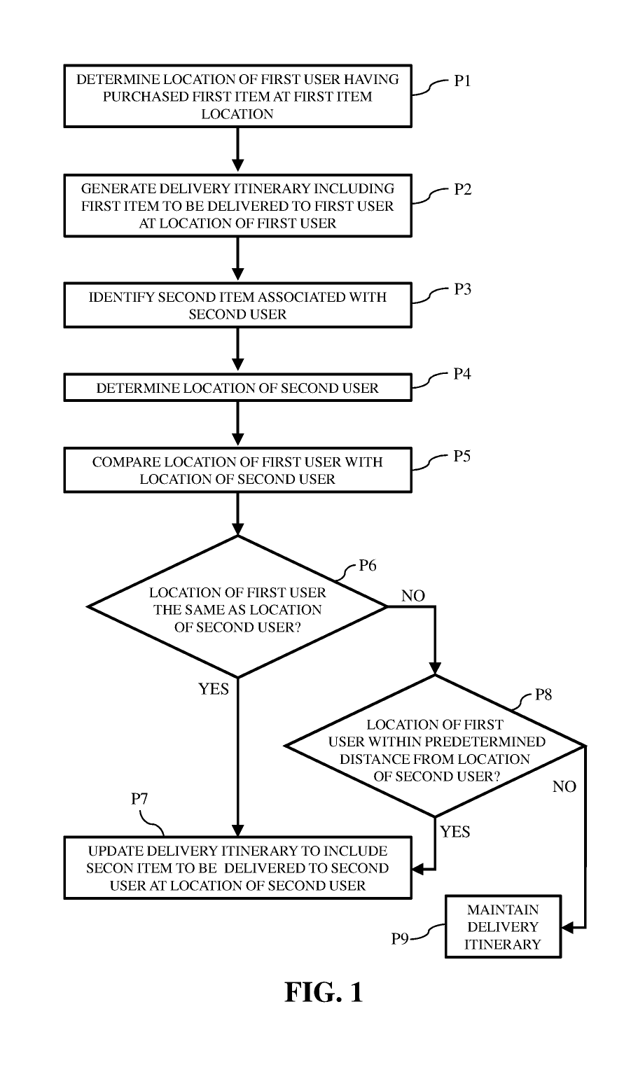

These and other embodiments are discussed below with reference to FIGS. 1-13. However, those skilled in the art will readily appreciate that the detailed description given herein with respect to these Figures is for explanatory purposes only and should not be construed as limiting.

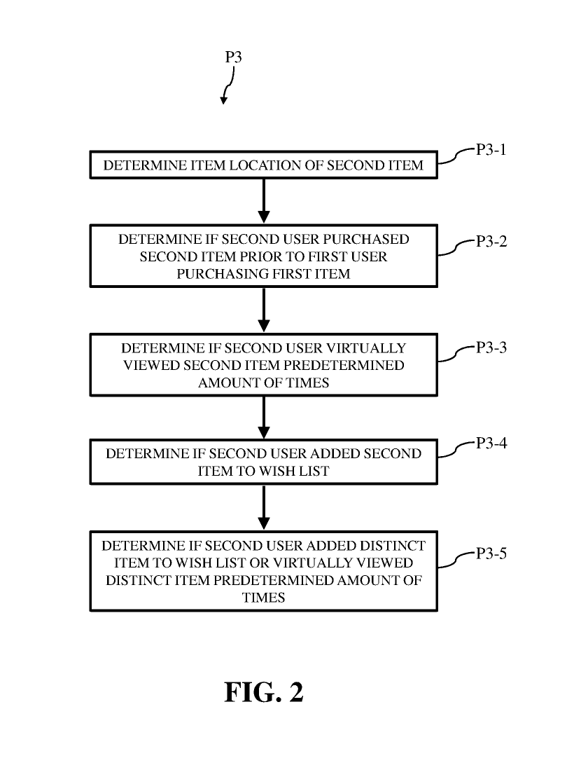

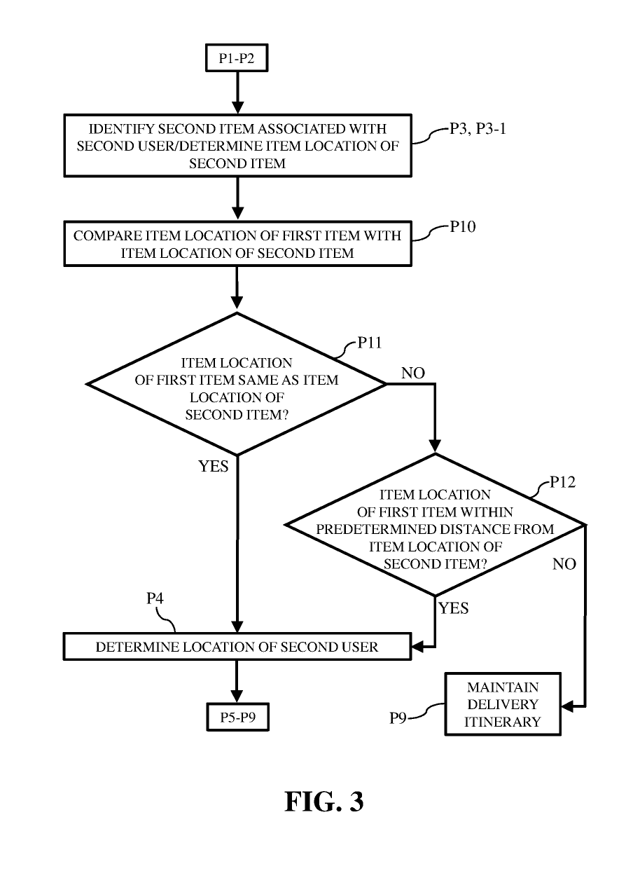

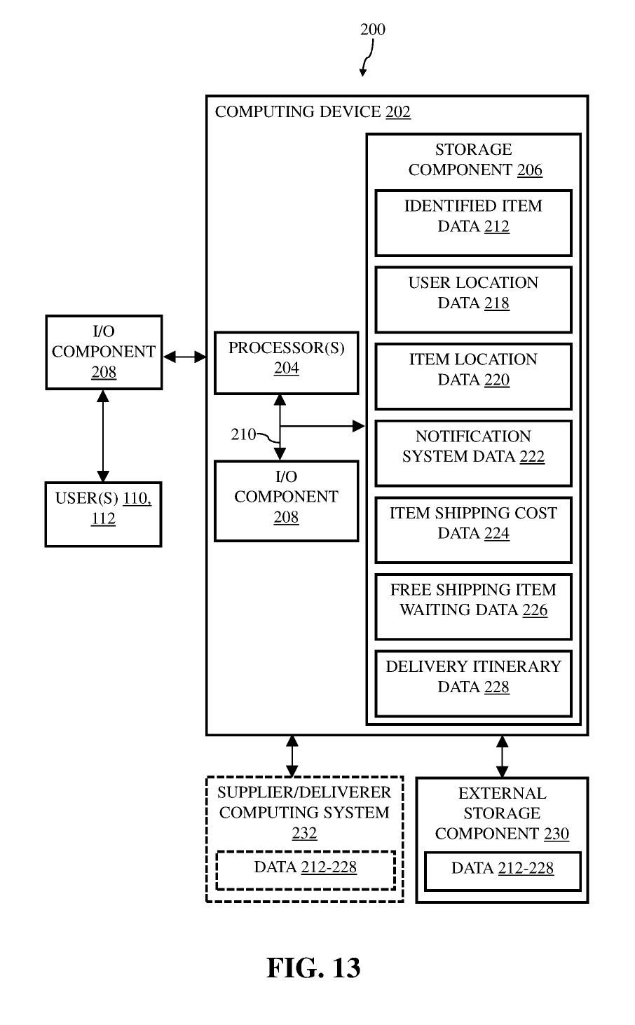

FIGS. 1-7 show various flow diagrams illustrating non-limiting example processes for aiding in a delivery of items to users. Specifically, FIG. 1 shows a flow diagram illustrating a non-limiting example of processes for aiding in a delivery of items to users, FIG. 2 shows non-limiting example processes for an identifying process (e.g., process P3) of FIG. 1, and FIGS. 3-7 show multiple, non-limiting variations of the processes for aiding in a delivery of items to users as shown in FIG. 1. These processes can be performed, e.g., by at least one computing device (see, FIG. 13), as described herein. In other cases, these processes can be performed according to a computer-implemented method for aiding in a delivery of items to users. In still other embodiments, these processes can be performed by executing computer program code on the computing device(s) included in at least one computing device, causing the computing device(s) to aid in a delivery of items to users.

Turning to FIG. 1, in process P1 a location of a first user may be determined. More specifically, a location of the first user who purchased a first item is determined. The determined location may be a desired delivery location for the first item purchased by the first user. For example, the location of the first user may be the first user's place of residency or place of business. The determined location of the first user may be established and/or designated by the first user when the first user purchases the first item. The first item purchased by the first user may be stored and/or stocked at a first item location. The first item location of the first item may be associated and/or correspond to a location, store, warehouse, and/or storage place of a supplier and/or deliverer of the first item. As a result of the first item being stored at the first item location, determining the location of the first user may include determining the geographical area of the first user and/or the geographical separation between the item location of the first item and the first user.

In a non-limiting example, the first user may purchase the first item, and may also pay an associated shipping cost. The shipping cost paid by the first user may determine when the first user may anticipate receiving the first item. That is, upon purchasing the first item, the first user may be prompted or provided shipping options for the first time, where each shipping option may include a set shipping cost and an anticipated date in which the first user may receive the first item based on the shipping cost. In another non-limiting example, the first user may opt for free shipping (e.g., no shipping cost), and may be provided with an anticipated date in which the first user may receive the first item.

In process P2, a delivery itinerary may be generated. Specifically, a delivery itinerary may be generated, created, produced, displayed, and/or printed for a future date. The delivery itinerary may include the first item to be delivered to the first user at the location of the first user on the future date. In non-limiting examples, the delivery itinerary may be a print out or list of items (e.g., first item) to be delivered on the future date. Additionally, the delivery itinerary may include the locations in which the items are to be delivered (e.g., location of first user). In other non-limiting examples, the generated delivery itinerary may include directions and/or a travel route between the item location of the first item and the determined location of the first user who purchased the first item (e.g., process P1). The future date of the delivery itinerary may correspond to the anticipated date in which the first user may receive the first item, as determined by the shipping cost paid by the first user purchasing the first item.

In process P3, a second item may be identified. Specifically, a second item associated with a second user may be identified. The second item may be distinct from the first item. Additionally, the second user associated with the second item may be distinct from the first user associated with and/or who purchased the first item. The second item may be identified based on predetermined item characteristics. That is, identifying the second item associated with the second user may include determining if the second item includes and/or has predetermined item characteristics. In non-limiting examples, the predetermined item characteristics that may identify and/or aid in the identification of the second item may include, but are not limited to a size of the second item, a geometry of the second item, a weight of the second item, a total parts number or quantity of the second item, a purchase price, and the like. The predetermined item characteristics used to identify the second item associated with the second user may be characteristics of the second item that aid in grouping the delivery of the second item with the first item to improve the delivery of the respective items for users, as discussed herein.

Identifying the second item associated with the second user in process P3 may include a plurality of additional processes. Briefly turning to FIG. 2, various, non-limiting example processes for identifying the second item in process P3 shown in FIG. 1 are depicted. For example, and in addition to identifying the second item based on predetermined item characteristics, identifying the second item associated the second user (e.g., process P3; FIG. 1) may include determining the item location of the second item. That is, in process P3-1 the item location of the second item associated with the second user may be determined. The item location of the second item may be associated and/or correspond to a location, store, warehouse, and/or storage place of a supplier and/or deliverer of the second item. In non-limiting examples, the item location of the second item associated with the second user may be the same or distinct location as the item location of the first item associated with the first user.

Additionally, or alternatively, identifying the second item associated the second user (e.g., process P3; FIG. 1) may include determining if the second user purchased the second item. Specifically, process P3-2 may include determining if the second user purchased the second item prior to the first user purchasing the first item. As discussed herein, a second user may have previously purchased (e.g., previously purchased) the second item at a past date, and/or a date that precedes the purchase date of the first item by the first user. Additionally, and as discussed herein, the second user may designated, defined, and/or selected a duration of time in which the second user is willing wait for free or reduced shipping costs for delivery of the second item at the time of purchase of the second item. As discussed herein, and unless otherwise defined, the term “purchase” may be understood as the second user pre-purchasing and/or pre-ordering the second item.

Identifying the second item associated the second user (e.g., process P3; FIG. 1) may also include determining if the second user virtually viewed the second item a predetermined amount of times. That is, in process P3-3 the number of virtual views of the second item may be determined by analyzing virtual records and/or searchable history(ies) for programs or applications in which the user may view the second item. For example, determining the number of virtual views of the second item may include analyzing and/or searching through a cookies and/or browser history of an internet browser program or application used by the second user, and determining how many times the second user viewed a web page (e.g., informational page, point of sales page, and the like) for the second item. Then, the determined number of virtual views may be compared to a predetermined amount of virtual views or times in which an item may be viewed. The predetermined amount of virtual views or times in which an item may be viewed may (at least preliminarily) determine if the second user is interested and/or likely intends to purchase the second item. If the determined number of virtual views equals or exceeds the predetermined amount of times in which an item may be viewed, it may be determined and/or identified that the second user is interested in purchasing the second item, and the second user may be subsequently given the option and/or prompted to purchase the second item, as discussed herein. The predetermined amount of virtual views or times in which an item may be viewed may be defined and/or established, for example, by determining an average number of times a user may virtually view an item prior to purchasing the item.

Additionally, identifying the second item associated the second user (e.g., process P3; FIG. 1) may also include determining if the second user added the second item to an item wish list. That is, in process P3-4 it may be determined if the second user, who virtually viewed the second item at a previous time or date, added the second item to a wish list. In a non-limiting example, the wish list may be a user-defined list or collection of items included on a supplier's and/or user's virtual viewing application or program (e.g., the supplier's website for the second item). Although discussed as an item wish list, it is understood that process P3-4 may include determining if the second user added the second item to any user-defined lists or collections including, but not limited to a favorites list, a watch list, an item notification/alert list, a price check list, a bookmark, or any other list or item collection that indicates that the second user is interested in the second item and/or would like to more easily or readily (virtually) view the second item at a later date.

Furthermore, identifying the second item associated with the second user (e.g., process P3; FIG. 1) may also include determining if the second user added a distinct item to an item wish list, and/or virtually viewed the distinct item a predetermined amount of times in process P3-5. The distinct item added to the item wish list and/or virtually viewed the predetermined amount of times may include similar or identical item characteristics as a second item. The similar or identical item characteristics between the distinct item and the second item may include, but are not limited to, items that function substantially similar or are intended for identical purposes/functions. For example, if it is determined the second user adds a widget manufactured by a first manufacturer (e.g., distinct item) to a wish list, an identical, same, and/or interchangeable widget manufactured by a second manufacturer (e.g., second item) may be identified in the process herein. In another non-limiting example, if it is determined the second user virtually views a hardcover version of a book by an author (e.g., distinct item) a predetermined amount of times, a softcover version of the same book by the same author (e.g., second item) may be identified in the process herein. It should be noted that the price or cost of the distinct item and the second item may not need to be identical or similar, and/or may not be a predefined item characteristic.

Process P3-5, including the distinct item, may be substantially similar and/or may be performed in a similar manner as processes P3-3 and P3-4 discussed herein with respect to the second item. The difference may be that process P3-5 is performed with respect to the distinct item that is distinct from, but includes similar item characteristics as the second item, as discussed herein. Additionally, and as discussed herein, the purpose of process P3-5 relating to the distinct item is to find a replacement for the distinct item and/or determine if the identified second item can be substituted for the distinct item, and shipped/delivered to the second user, along with the delivery of the first item to the first user, when the distinct item is not readily available for delivery to the second user.

Although shown in succession and/or in a predefined order (e.g., P3-1-P3-5), it is understood that all of the discussed and depicted processes for identifying the second item in process P3 may be performed and/or determined substantially at the same time and/or concurrently. Additionally, although process P3 is shown and discussed herein to include all of processes P3-1-P3-5, it is understood that any number of these processes shown and discussed herein with respect to FIG. 2 can be used to identify the second item associated with the second user in process P3. As discussed herein with respect to the non-limiting examples shown in FIGS. 3-7, any or all of the process P3-1-P3-5 may be used and/or performed in the identifying of process P3.

Returning to FIG. 1, a location of the second user may be determined in process P4. More specifically, a location of the second user who is associated with the identified second item is determined in process P4. Similar to the location of the first user, the determined location of the second user may be a desired delivery location for the second item associated with the second user. For example, the location of the second user may be the second user's place of residency or place of business. The determined location of the second user may be established and/or designated by the second user when the second user purchases the second item and/or is identified as being associated with the second item. Also similar to the determined location of the first user, and as a result of the second item being stored at the determined item location, determining the location of the second user may include determining the geographical area of the second user and/or the geographical separation between the item location of the second item and the second user.

In process P5, the location of the first user may be compared to the location of the second user. Specifically, the determined location of the first user who purchased the first item may be compared to the determined location of the second user who is associated with and/or purchased the second item. In the non-limiting examples discussed herein, process P5 may include comparing the desired delivery location for the first item purchased by the first user with the desired delivery location for the second item associated with the second user.

In process P6, it is determined if the location of the first user is the same as the location of the second user. Specifically, it may be determined if the determined location of the first user who purchased the first item is the same as the determined location of the second user who is associated with and/or purchased the second item. If the determined location of the first user is the same as the determined location of the second user (e.g., “YES” at process P6), the processes may continue to process P7. Conversely, if the determined location of the first user is not the same as the determined location of the second user (e.g., “NO” at process P6), the processes may proceed to process P8.

In response to determining the location of the first user is the same as the location of the second user (e.g., “YES” at process P6), the delivery itinerary may be updated at process P7. Specifically at process P7, the delivery itinerary generated for the future date in process P2 may be updated, altered, changed, and/or added upon in response to determining the determined location of the first user who purchased the first item is the same as the determined location of the second user who is associated with and/or purchased the second item. Updating the delivery itinerary in process P7 may include adding the second item to be delivered to the second user at the location of the second user. As such, the updated delivery itinerary may now include the first item to be delivered to the first user at the location of the first user, as well as, the second item to be delivered to the second user at the location of the second user.

Continuing the non-limiting examples discussed herein with respect to process P2, the updated delivery itinerary may include a new or updated print out or list of items (e.g., first item, second item) to be delivered on the future date. Additionally, the delivery itinerary may include the locations in which the items are to be delivered (e.g., location of first user, location of second user). In other non-limiting examples, the generated delivery itinerary may include directions and/or a travel route between the item location of the first item and the determined location of the first user who purchased the first item (e.g., process P1), and the item location of the second item and the determined location of the second user who purchased the second item (e.g., processes P3 and P4).

In response to determining the location of the first user is distinct from or not the same as the location of the second user (e.g., “NO” at process P6), it may be determined if the location of the first user is within a predetermined distance of the location of the second user at process P8. Specifically in process P8, it may be determined if the determined location of the first user who purchased the first item is within a predetermined distance of the determined location of the second user who is associated with and/or purchased the second item. The predetermined distance between the location of the first user and the location of the second user may be determined and/or defined by the supplier and/or deliverer of the first item and the second item. For example, the predetermined distance may include a predetermined and/or predefined distance (e.g., mileage) range or threshold established by the supplier and/or deliverer of the first item and the second item who may deliver the first item to the location of the first user and the second item to the location of the second user, respectively. Additionally, or alternatively, the predetermined distance may also include a similarity threshold (e.g., predetermined percentage) in the delivery directions and/or a travel route between the item location of the first item and the determined location of the first user who purchased the first item, and the item location of the second item and the determined location of the second user who purchased the second item.

The predetermined distance may aid in the delivery of the first item to the first user and potentially the delivery of the second item to the second user. That is, the predetermined distance may correspond to a distance threshold in which the deliverer of the first item may also deliver the second item to the location of the second user without accruing and/or adding any additional costs associated with the delivery of the second item, or alternatively, where the deliverer only accrues and/or adds minimal or inconsequential costs associated with the delivery of the second item in addition to the delivery of the first item. The additional costs may relate to, for example, the cost of gas for delivering each item, the time associated with driving/delivering the second item along with the first item, mechanical wear experienced by a vehicle used to deliver the items, multiple trips being taken to the same location over a single day or multiple days to deliver multiple items, and the like.

If the determined location of the first user is within the predetermined distance from the determined location of the second user (e.g., “YES” at process P8), the processes may continue to process P7. Conversely, if the determined location of the first user is not within the predetermined distance from the determined location of the second user (e.g., “NO” at process P8), the processes may proceed to process P9. In process P9, the delivery itinerary may be maintained. More specifically in process P9, the delivery itinerary generated in process P2 may be maintained, unaltered, and/or not updated as in process P7, but rather may be maintained or identical to when the delivery itinerary is initially generated. In the non-limiting example where it is determined that the determined location of the first user is not within the predetermined distance from the determined location of the second user (e.g., “NO” at process P8), the delivery itinerary may continue to and/or may only include the first item to be delivered to the first user at the location of the first user on the future date (e.g., process P2).

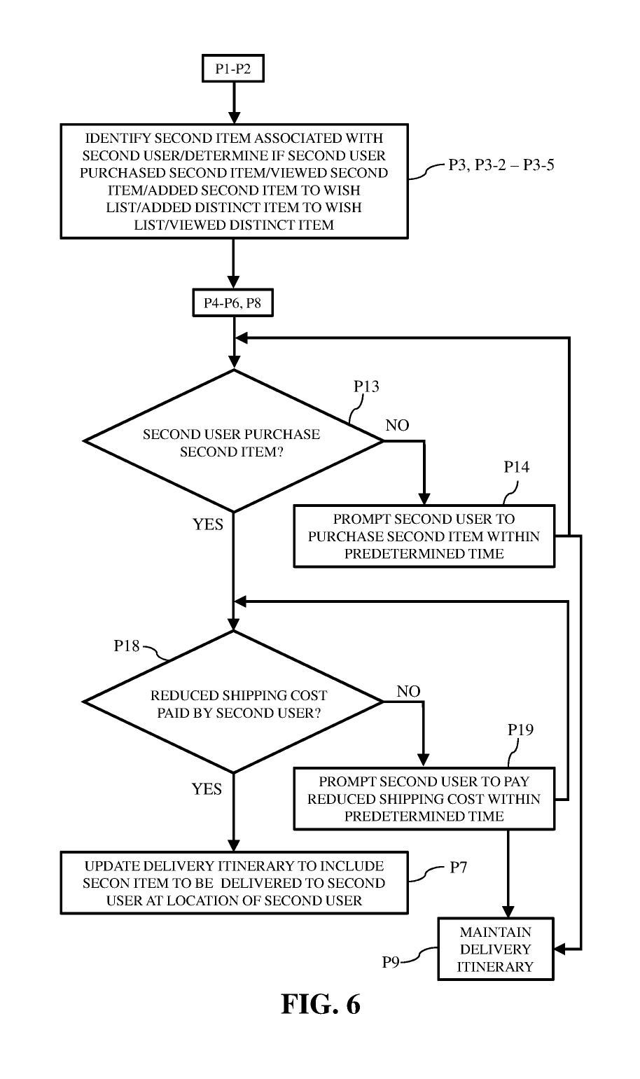

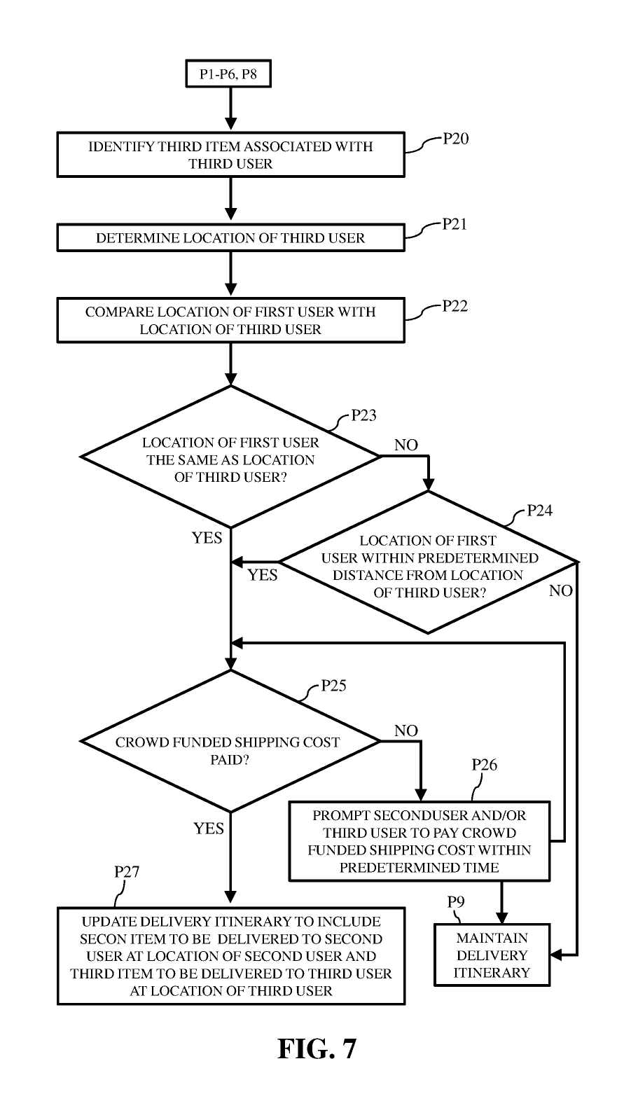

The processes discussed herein with respect to FIG. 1, and the non-limiting alternative examples discussed herein with respect to FIGS. 3-7, may aid in the delivery of multiple items to multiple users in a single delivery. As such, all parties involved in the transaction (e.g., the second user, the supplier, the deliverer) may experience a benefit from delivering the second item to the location of the second user at the same time and/or as part of the same delivery itinerary as the first item being delivered to the location of the first user. For example, and as previously discussed herein with respect to the predetermined distance in process P8, following the processes discussed herein may ensure that a deliverer of the first item may also deliver the second item without accruing and/or adding any additional cost, or only adding minimal/inconsequential additional costs associated with the delivery of the second item. Additionally, the second user may benefit by receiving the second item with no shipping cost or a reduced shipping cost (see, FIGS. 6 and 7). Finally, the supplier of the first item and the second item may benefit by increasing sales by providing users the ability to receive free shipping for items that include predetermined item characteristics, as similar discussed herein with respect to process P3. This may be especially true and beneficial for suppliers where a user (e.g., second user) may not purchase an item (e.g., second item) because of the associated shipping cost.

FIGS. 3-7 show various non-limiting examples of processes for aiding in the delivery of items to users. The non-limiting examples shown in FIGS. 3-7 may include identical processes as those shown and discussed herein with respect to the processes of FIGS. 1 and/or 2. For example, the non-limiting example processes shown in FIG. 3 may include process P1 (e.g., determining the location of the first user), process P2 (e.g., generating a delivery itinerary), process P5 (e.g., comparing the location of the first user with the location of the second user), and so on (e.g., processes P6-P9), as previously discussed herein with respect to FIG. 1. In these non-limiting examples, it is understood the processes may proceed through to process P7 (e.g., updating the delivery itinerary) or to process P9 (e.g., maintaining the delivery itinerary); dependent upon the preceding processes. It is also understood that similarly numbered and/or named processes may function in a substantially similar fashion and/or may include substantially similar processes being performed. Redundant explanation of these processes have been omitted for clarity.

Turning to FIG. 3, and as similarly discussed herein with respect to FIG. 2, the identifying of the second item associated with the second user in process P3 may further include determining the item location of the second item (e.g., process P3-1). That is, identifying the second item in process P3 may specifically include process P3-1 (see, FIG. 2) where the item location of the second item associated with the second user is determined. As discussed herein, the item location of the second item may be associated and/or correspond to a location, store, warehouse, and/or storage place of a supplier and/or deliverer of the second item.

In process P10, the item location of the first item may be compared to the item location of the second item. Specifically in process P10, the determined item location of the first item purchased by the first user may be compared to the determined item location of the second item associated with and/or purchased by the second user. In the non-limiting examples discussed herein, process P10 may include comparing the location, store, warehouse, and/or storage place of a supplier and/or deliverer of the first item with the location, store, warehouse, and/or storage place of a supplier and/or deliverer of the second item.

In process P11, it is determined if the item location of the first item is the same as the item location of the second item. Specifically in process P11, it may be determined if the determined item location of the first item purchased by the first user is the same as the determined item location of the second item associated with and/or purchased by the second user. If the determined item location of the first item is the same as the determined item location of the second item (e.g., “YES” at process P11), the processes may continue to process P4, and subsequently to processes P5-P9, as discussed herein with respect to the processes shown FIG. 1. Conversely, if the determined item location of the first item is not the same as the determined item location of the second item (e.g., “NO” at process P11), the processes may proceed to process P12.

In response to determining the item location of the first item is distinct from or not the same as the item location of the second item (e.g., “NO” at process P11), it may be determined if the item location of the first item is within a predetermined distance of the item location of the second item at process P12. Specifically in process P12, it may be determined if the determined item location of the first item purchased by the first user is within a predetermined distance of the determined item location of the second item associated with and/or purchased by the second user. As similarly discussed herein with respect to the predetermined distance of process P8, the predetermined distance between the item location of the first item and the item location of the second item may be determined and/or defined by the supplier and/or deliverer of the first item and the second item. Additionally, and as discussed herein, the predetermined distance may aid in the delivery of the first item to the first user and potentially the delivery of the second item to the second user by eliminating or minimizing additional costs (e.g., fuel, time of delivery, and so on) to the deliverer of the first item and the second item.

If the determined item location of the first item is within the predetermined distance from the determined item location of the second item (e.g., “YES” at process P12), the processes may continue to process P4, and subsequently through processes P5-P9 as discussed herein. Conversely, if the determined item location of the first item is not within the predetermined distance from the determined item location of the second item (e.g., “NO” at process P12), the processes may proceed to process P9 where the delivery itinerary may be maintained, also as previously discussed herein.

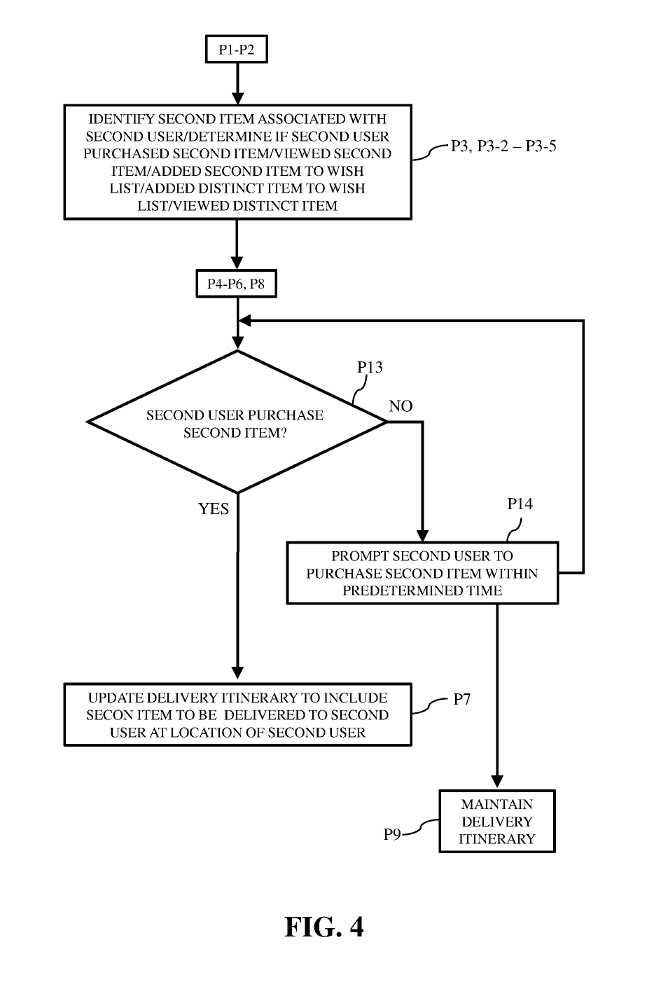

FIG. 4 shows another non-limiting example processes for aiding in the delivery of items to users. As such in FIG. 4, and previously discussed herein with respect to FIG. 2, the identifying of the second item associated with the second user in process P3 may further a plurality of additional processes. For example, the identifying of the second item associated with the second user in process P3 may also include determining if the second user purchased the second item prior to the first user purchasing the first item (e.g., process P3-2), determining if the second user virtually viewed the second item a predetermined amount of times (e.g., process P3-3), determining if the second user added the second item to a wish list (e.g., process P3-4), and/or determining if the second user added a distinct item to a wish list and/or virtually viewed a distinct item a predetermined amount of times (e.g., process P3-5). As discussed herein with respect to process P3-5, the distinct item may include similar or identical item characteristics as the identified second item. Additionally in the non-limiting example, it is understood that the identified second item associated with the second user may be capable of being delivered with the first item (e.g., within the same item location), so long as the subsequent processes result in updating the delivery itinerary (e.g., process P7), as discussed herein.

Subsequent to performing process P3 including process P3-2-P3-5, processes P4-P6 may be performed, as similarly discussed herein with respect to FIG. 1. Also when applicable, process P8 may be performed. In response to determining the location of the first user is the same as the location of the second user (e.g., “YES” at process P6), or determining the location of the first user is within the predetermined distance of the location of the second user (e.g., “YES” at process P8), process P13 may be performed.

In process P13, it is determined if the second user purchased the second item. Specifically at process P13 it is determined if the second user purchased the second item, independent of when the first user purchased the first item. For example, it is determined if the second user purchased the second item either before or after the first user purchased the first item. Determining if the second user purchased the second item may be achieved by analyzing purchase information from the supplier and/or deliverer of the second item. If the second user did purchase the second item (e.g., “YES” at process P13), the processes may continue to process P7. Conversely, if it is determined that the second user did not purchase the second item (e.g., “NO” at process P13), but merely virtually viewed the second item the predetermined amount of times (e.g., process P3-3), added the second item to a wish list (e.g., process P3-4), and/or added a distinct item to a wish list or virtually viewed the distinct item the predetermined amount of times (e.g., process P3-5), the processes may proceed to process P14.

In process P14, the second user may be prompted to purchase the second item. Specifically, the second user associated with the second item, who at the time did not purchase the second item, may be prompted to purchase the second item within a predetermined time prior to updating the delivery itinerary for the future date in process P14. The second user may be prompted to purchase the second item using any suitable notification system, application, and/or process for providing a notification via an electronic device. For example, the second user may be prompted to purchase the second item by sending the second user an e-mail notification, a short message service (SMS) message, a multimedia messaging service (MMS) message, calling the second user, and the like. The predetermined time may be a time defined by the supplier and/or deliverer of the second item. The predetermined time prior to updating the delivery itinerary for the future date may ensure that if the second user purchases the second item within the predetermined time, the second item will be shipped/delivered to the second user when the first item is delivered to the first user on the future date.

Once the second user is prompted to purchase the second item in process P14, process P13 may be performed again at the expiration of the predetermined time. Specifically, at the expiration of the predetermined time prior to updating the delivery itinerary for the future date, it may be determined if the second user has purchased the second item. If it is determined that the second user purchased the second item after being prompted in process P13 and/or before the expiration of the predetermined time prior to updating the delivery itinerary (e.g., “YES” at process P13 (second inquiry)), the processes may continue to process P7. However, if it is determined that the second user did not purchased the second item after being prompted in process P13 and/or before the expiration of the predetermined time prior to updating the delivery itinerary (e.g., “NO” at process P13 (second inquiry)), the processes may proceed to process P9.

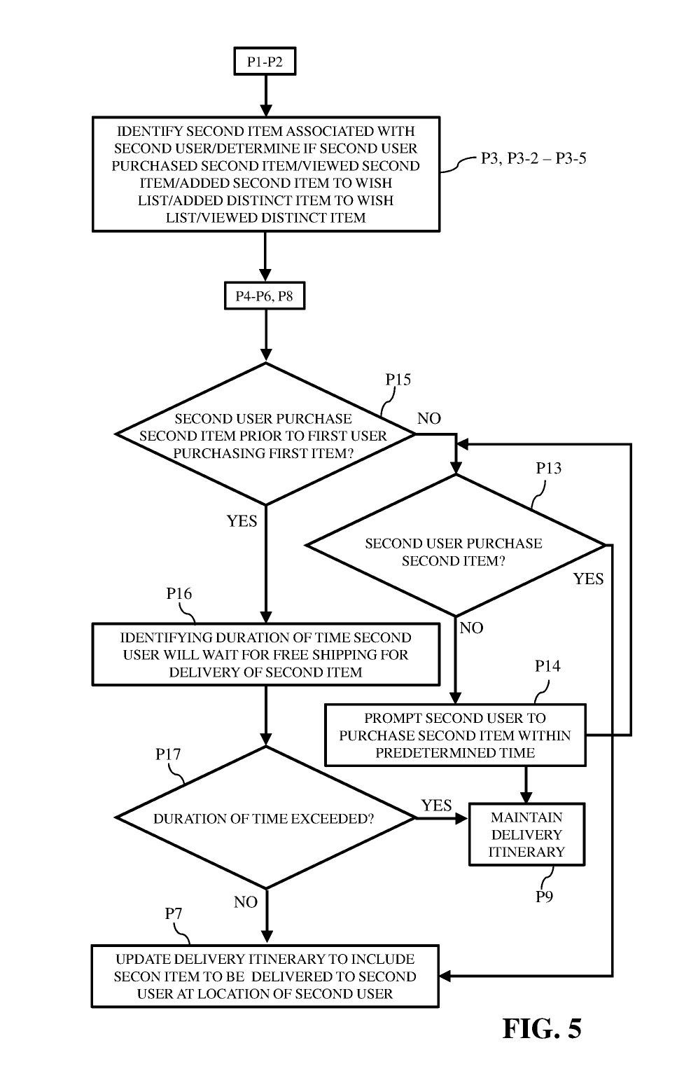

FIG. 5 shows non-limiting example processes for aiding in the delivery of items to users that includes similar processes, as well as, additional processes as those shown and discussed herein with respect to FIG. 4. For example, in process P15, it is determined if the second user purchased the second item prior to the first user purchasing the first item. That is at process P15, and distinct from process P13, it is determined if the second user purchased the second item prior to the first user purchasing the first item. Similar to process P13 discussed herein with respect to FIG. 4, determining if the second user purchased the second item prior to the first user purchasing the first item may be achieved by analyzing purchase information from the supplier and/or deliverer of the first item and second item, respectively. If the second user did purchase the second item prior to the first user purchasing the first item (e.g., “YES” at process P15), the processes may continue to process P16. Conversely, if it is determined that the second user did not purchase the second item prior to the first user purchasing the first item (e.g., “NO” at process P15), the processes may proceed to processes P13 and P14 as similarly discussed herein with respect to FIG. 4.

In response to determining the second user did purchase the second item prior to the first user purchasing the first item at process P15, a duration of time the second user is willing to wait for free shipping for delivery of the second item may be identified in process P16. That is, process P16 may include identifying a duration of time the second user is willing to wait for free shipping for delivery of the second item. As discussed herein, the free shipping cost for delivery of the second item to the location of the second user may be accomplished or achieved by updating the delivery itinerary (e.g., process P7) and shipping/delivering the second item along with the first item. The duration of time the second user is willing to wait for free shipping for delivery of the second item may be defined by the second user. For example, when the second user purchases the second item, the second user may opt or be provided the option to set or define a duration of time in which the second user is willing to waiting for another user (e.g., first user) to purchase an item (e.g., first item) in which the second item may be joined in the delivery itinerary and/or delivered with the first item at no shipping cost to the second user.

At process P17, it may be determined if the duration of time the second user is willing to wait for free shipping for delivery of the second item is exceeded. Specifically at process P17, it may be determined if the duration of time the second user is willing to wait for free shipping for delivery of the second item, as defined by the user when purchasing the second item, is exceeded and/or has expired. If the duration of time the second user is willing to wait for free shipping for delivery of the second item is exceeded and/or has expired (e.g., “YES” at process P17), the processes may continue to process P9. Additionally in a non-limiting example, if the duration of time the second user is willing to wait for free shipping for delivery of the second item is exceeded and/or has expired (e.g., “YES” at process P17), and the processes continue to process P9, the second user may also be provided a refund for the purchased second item. Conversely, if the duration of time the second user is willing to wait for free shipping for delivery of the second item is not exceeded and/or has not expired (e.g., “NO” at process P17), the processes may continue to process P7.

Similar to the non-limiting example of FIG. 5, FIG. 6 shows non-limiting example processes for aiding in the delivery of items to users that includes similar processes, as well as, additional processes as those shown and discussed herein with respect to FIG. 4. For example, process P18 includes determining if a reduced shipping cost has been paid by the second user. Specifically in process P18, and subsequent to determining that the second user has purchased the second item, it may be determined if the second user paid a reduced shipping cost associated with the purchase of the second item. Upon purchasing the identified second item (e.g., process P3), the second user may be prompted to pay a reduced shipping cost for the shipping and/or delivery of the second item along with the delivery of the first item to the first user. Determining if the second user paid the reduced shipping cost may be achieved by analyzing purchase information from the supplier and/or deliverer of the second item.

Distinct from the non-limiting examples discussed herein with respect to FIGS. 1, and 3-5, the non-limiting example shown in FIG. 6 may require the second user to pay a shipping cost. However in this example, the shipping cost may be reduced and/or may be less than the normal shipping cost for the second item as a result of the second item being identified in process P3, determining that the second item may be included in the delivery itinerary including the first item and/or determining that the second item may be delivered to the determined location of the second user along with the first item being delivered to the determined location of the first user at the future date. In a non-limiting example (not shown), the shipping cost for the first item purchased by the first user may also be reduced if it is determined that the second user has paid the reduced shipping cost. In another non-limiting example (not shown), once it is determined that the second user has paid the reduced shipping cost, the first user may be refunded a portion of the shipping cost the first user paid in conjunction with purchasing the first item.

If it is determined that the second user has paid the reduced shipping cost (e.g., “YES” at process P18), the processes may continue to process P7. Conversely, if it is determined that the second user did not pay the reduced shipping cost when purchasing the second item (e.g., “NO” at process P18), the processes may proceed to process P19.

In process P19, the second user may be prompted to pay the reduced shipping cost. Specifically, the second user who purchased the second item may be prompted to pay the reduced shipping cost within a predetermined time prior to updating the delivery itinerary for the future date in process P19. Similar to the prompt provided in process P14, the second user may be prompted to pay the reduced shipping cost using any suitable notification system, application, and/or process for providing a notification via an electronic device. Also as similarly discussed herein with respect to process P14, the predetermined time may be a time defined by the supplier and/or deliverer of the second item that may ensure that if the second user pays the reduced shipping cost within the predetermined time, the purchased second item will be shipped/delivered to the second user when the first item is delivered to the first user on the future date.

Once the second user is prompted to pay the reduced shipping cost in process P19, process P18 may be performed again at the expiration of the predetermined time. Specifically, at the expiration of the predetermined time prior to updating the delivery itinerary for the future date, it may be determined if the second user has paid the reduced shipping cost associated with the purchased second item. If it is determined that the second user paid the reduced shipping cost in process P18 and/or before the expiration of the predetermined time prior to updating the delivery itinerary (e.g., “YES” at process P18 (second inquiry)), the processes may continue to process P7. However, if it is determined that the second user did not pay the reduced shipping cost after being prompted in process P19 and/or before the expiration of the predetermined time prior to updating the delivery itinerary (e.g., “NO” at process P18 (second inquiry)), the processes may proceed to process P9. Additionally in a non-limiting example, if the second user did not pay the reduced shipping cost (e.g., “NO” at process P18 (second inquiry)), and the processes continue to process P9, the second user may also be provided a refund for the purchased second item.

FIG. 7 shows non-limiting example processes for aiding in the delivery of items to users including similar processes discussed herein with respect to FIG. 1, but relating to a third item distinct from the first item and the second item, respectively. For example, the processes shown in FIG. 7 include processes P20-P24 relating to the third item (and associated third user), which may be substantially similar to processes P3-P6 and P8 shown and discussed herein with respect to FIG. 1.

In process P20, a third item associated with a third user, distinct from the first user and the second user, may be identified. Similar to the second item, the third item may be identified based on predetermined item characteristics, which may include, but are not limited to a size of the third item, a geometry of the third item, a weight of the third item, a total parts number or quantity of the third item, and the like. The predetermined item characteristics used to identify the third item associated with the third user may be characteristics substantially similar to those identified characteristics of the second item associated with the second user, and may aid in grouping the delivery of the third item with the first item and second item to improve the delivery of the respective items for users, as discussed herein. Additionally, and as similarly discussed herein with respect to FIG. 2, identifying the third item associated with the third user may include a plurality of additional processes (e.g., P3-1-P3-5; FIG. 2).

In process P21 a location of the third user who is associated with the identified third item is determined. Similar to the location of the first user and/or second user, the determined location of the third user may be a desired delivery location for and/or designated by the third item associated with the third user. For example, the location of the second user may be the second user's place of residency or place of business. As a result of the third item being stored at a determined item location, determining the location of the third user may include determining the geographical area of the third user and/or the geographical separation between the item location of the third item and the third user.

In process P22, the location of the first user may be compared to the location of the third user. Specifically, the determined location of the first user who purchased the first item may be compared to the determined location of the third user who is associated with and/or purchased the third item. In the non-limiting examples discussed herein, process P22 may include comparing the desired delivery location for the first item purchased by the first user with the desired delivery location for the third item associated with the third user.

In process P23, it is determined if the location of the first user is the same as the location of the third user. Specifically, it may be determined if the determined location of the first user who purchased the first item is the same as the determined location of the third user who is associated with and/or purchased the third item. If the determined location of the first user is the same as the determined location of the third user (e.g., “YES” at process P23), the processes may continue to process P25. Conversely, if the determined location of the first user is not the same as the determined location of the third user (e.g., “NO” at process P23), the processes may proceed to process P24.

In response to determining the location of the first user is distinct from or not the same as the location of the third user (e.g., “NO” at process P23), it may be determined if the location of the first user is within a predetermined distance of the location of the third user at process P24. Specifically in process P24, it may be determined if the determined location of the first user who purchased the first item is within a predetermined distance of the determined location of the third user who is associated with and/or purchased the third item. As similarly discussed herein with respect to process P8 and the predetermined distance between the location of the first user and the location of the second user, the predetermined distance between the location of the first user and the location of the third user may be determined and/or defined by the supplier and/or deliverer of the first item and the third item. Additionally, and as discussed herein, the predetermined distance may aid in the delivery of the first item to the first user and potentially the delivery of the third item to the third user by eliminating or minimizing additional costs (e.g., fuel, time of delivery, and so on) to the deliverer of the first item and the third item.

If the determined location of the first user is within the predetermined distance from the determined location of the third item (e.g., “YES” at process P24), the processes may continue to process P25. Conversely, if the determined location of the first user is not within the predetermined distance from the determined location of the third user (e.g., “NO” at process P24), the processes may proceed to process P9 where the delivery itinerary may be maintained, also as previously discussed herein.

In response to determining the location of the first user is the same as (e.g., “YES” at process P23) or within the predetermined distance from the location of the third user (e.g., “YES” at process P24), it may be determined if a crowd funded shipping cost has been paid at process P25. Specifically in process P25, it may be determined if a crowd funded shipping cost has been paid by the second user purchasing the second item and/or the third user purchasing the third item. Upon purchasing the identified second item (e.g., process P3) and/or third item (e.g., process P20), the second user and/or third user may be prompted to pay and/or contribute to a crowd funded shipping cost for the shipping and/or delivery of the second item and/or third item along with the delivery of the first item to the first user. Additionally, or in an alternative non-limiting example, it may be determined if the crowd funded shipping cost has been paid by at least one distinct user at process P25. The at least one distinct user may be distinct from the first user, the second user, and the third user, respectively, and may be a user(s) associated with a distinct item (e.g., not first item, second item third item) or alternatively may just be a user(s) who has “donated” or voluntarily paid the crowd funded shipping cost. Determining if the second user, third user and/or distinct user(s) have paid and/or contributed to the crowd funded shipping cost may be achieved by analyzing purchase information from the supplier and/or deliverer of the second item and/or third item.

Similar to the non-limiting example shown in FIG. 6, the processes of FIG. 7 may require the second user and/or the third user to pay a shipping cost. However in this example, the shipping cost may be crowd funded and/or may be paid by or contributed to by any users (e.g., second user, third user) that may purchase items having predetermined item characteristics that may be shipped and/or delivered with the first item purchased by the first user. The crowd funded shipping cost may be paid by any user who purchased an item including the predetermined item characteristics. As such, in non-limiting examples, the crowd funded shipping cost may be paid in full by either the second user or the third user, or alternatively, the crowd funded shipping cost may be paid in full by contributions from both the second user and the third user. Regardless of which user pays the crowd funded shipping cost, if the entirety of the crowd funded shipping cost is paid in full, the identified items (e.g., the second item, the third item) will ship and/or be delivered on the future date along with the first item, as discussed herein.

If it is determined that the second user and/or the third user has paid the crowd funded shipping cost (e.g., “YES” at process P25), the processes may continue to process P27. Conversely, if it is determined that the second user and/or the third user did not pay the crowd funded shipping cost (e.g., “NO” at process P25), the processes may proceed to process P26.

In process P26, the second user and/or third user may be prompted to pay the crowd funded shipping cost. Specifically, the second user who purchased the second item and/or the third user who purchased the third item may be prompted to pay and/or contribute to the crowd funded shipping cost within a predetermined time prior to updating the delivery itinerary for the future date in process P26. Similar to the prompt provided in process P14, the second user and/or the third user may be prompted to pay and/or contribute to the crowd funded shipping cost using any suitable notification system, application, and/or process for providing a notification via an electronic device. Also as similarly discussed herein with respect to process P14, the predetermined time may be a time defined by the supplier and/or deliverer of the second item and/or the third item that may ensure that if the crowd funded shipping cost is paid in full within the predetermined time, the purchased second item and third item will be shipped/delivered to the second user and third user, respectively, when the first item is delivered to the first user on the future date.

Once the second user and/or third user is prompted to pay the crowd funded shipping cost in process P26, process P25 may be performed again at the expiration of the predetermined time. Specifically, at the expiration of the predetermined time prior to updating the delivery itinerary for the future date, it may be determined if the crowd funded shipping cost associated with the purchased second item and the purchased third item has been paid in full. If it is determined that the second user and/or the third user paid the crowd funded shipping cost in process P25 and/or before the expiration of the predetermined time prior to updating the delivery itinerary (e.g., “YES” at process P25 (second inquiry)), the processes may continue to process P27. However, if it is determined that the crowd funded shipping cost is not paid in full after being prompted in process P19 and/or before the expiration of the predetermined time prior to updating the delivery itinerary (e.g., “NO” at process P25 (second inquiry)), the processes may proceed to process P9. In another non-limiting example, if the crowd funded shipping cost is not paid in full (e.g., “NO” at process P25 (second inquiry)), and the processes continue to process P9, the second user may also be provided a refund for the purchased second item and/or the third user may be provided a refund for the purchased third item.

In response to determining that the second user and/or the third user paid the crowd funded shipping cost before the expiration of the predetermined time (e.g., “YES” at process P25), the delivery itinerary may be updated at process P27. Specifically at process P27, and similar to process P7 discussed herein, the delivery itinerary generated for the future date in process P2 may be updated, altered, changed, and/or added upon in response to determining the crowd funding shipping cost has been paid in full by the second user and/or the third user.

Updating the delivery itinerary in process P27 may include adding the second item to be delivered to the second user at the location of the second user, and adding the third item to be delivered to the third user at the location of the third user. As such, the updated delivery itinerary at process P27 may now include the first item to be delivered to the first user at the location of the first user, the second item to be delivered to the second user at the location of the second user, and the third item to be delivered to the third user at the location of the third user.

Similar to the non-limiting examples discussed herein with respect to process P2 shown in FIG. 1, the updated delivery itinerary may include a new or updated print out or list of items (e.g., first item, second item, third item) to be delivered on the future date. Additionally, the delivery itinerary may include the locations in which the items are to be delivered (e.g., location of first user, location of second user, location of third user). In other non-limiting examples, the generated delivery itinerary may include directions and/or a travel route between the item location of the various items and the determined location of the various users who purchased the items (e.g., processes P1, P3, and P20).

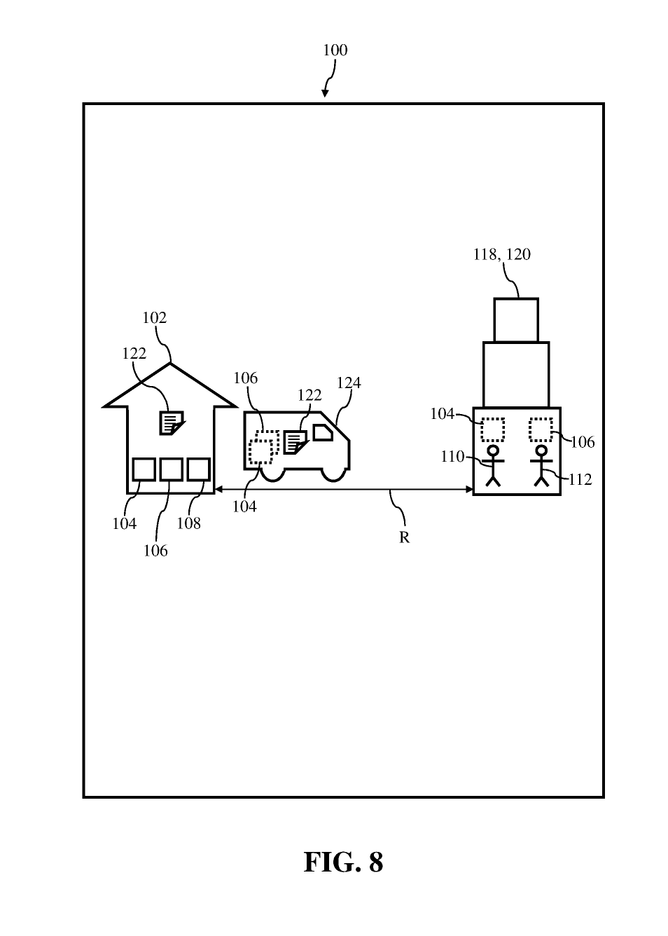

FIGS. 8-12 depicts non-limiting examples of an environment include a plurality of items at an item location(s), and a plurality of users at a delivery location(s). Specifically, the non-limiting examples shown in FIGS. 8-12 may include environments include a plurality of items at an item location(s), and a plurality of users at a delivery location(s), prior to the item(s) being delivered to the delivery locations, but after a delivery itinerary is generated/updated/maintained, as discussed herein. The items may be delivered to the users in FIGS. 8-12 by performing the processes P1-P27 discussed herein with respect to FIGS. 1-7. It is understood that similarly numbered and/or named components may function in a substantially similar fashion. Redundant explanation of these components has been omitted for clarity.

Turning to the non-limiting example shown in FIG. 8, an environment 100 is shown. The environment includes an item location 102 for a plurality of items including, for example, a first item 104, a second item 106, and a third item 108. As discussed herein, item location 102 may include and/or correspond to a location, store, warehouse, and/or storage place of a supplier and/or deliverer of the plurality of items 104, 106, 108. Additionally, environment 100 shown in FIG. 8 may include a first user 110, and a second user 112, distinct form first user 110. In the non-limiting example, and as discussed herein, first user 110 may be associated with and/or may have purchased first item 104 stored at item location 102, and second user 112 may be associated with and/or may have purchased second item 106 stored at item location 102.

Additionally as discussed herein, each of first user 110 and second user 112 may have a determined and/or identified location 118, 120. Specifically, first user 110 may have and/or be located at a location 118, and second user 112 may have and/or be located at a location 120. Location 118, 120 of the users 110, 112 may be the user's place of residency or place of business, and/or may be the user determined and/or identified location in which items 104, 106 may be delivered. In the non-limiting example shown in FIG. 8, location 118 of first user 110 may be the same and/or identical (e.g., same apartment building, same work building) as location 120 of second user. 112.

Performing the processes discussed herein with respect to FIGS. 1-7, it may be determined that second item 106 associated with second user 112 may be delivered with first item 104 associated with first user 110. For example, and with reference to process P1-P7 of FIG. 1, location 118 of first user 110 having purchased first item 104 at first item location 102 may be determined (e.g., process P1), and a delivery itinerary 122 may be generated at item location 102 to include first item 104 to be delivered to first user 110 at location 118 at a future date (e.g., process P2). Next, second item 106 associated with second user 112, and located at item location 102, may be identified (e.g., process P3), and location 120 of second user 112 may be determined (e.g., process P4), and compared to location 118 of first user 110 (e.g., process P5). In response to determining location 120 of second user 112 is the same as location 118 of first user 110 (e.g., “YES” at process P6), delivery itinerary 122 may be updated to include first item 104 to be delivered to first user 110 at location 118, and second item 106 to be delivered to second user 112 at location 120 at the future date (e.g., process P7). When the future date arrives, both first item 104 and second item 106 may be loaded onto a delivery vessel 124, which may in turn deliver first item 104 to first user 110 at location 118, and second item 106 to second user 112 at location 120. Delivery vessel 124 may deliver first item 104 and second item 106 may traveling along a predetermined and/or delivery route “R” which includes the least amount of travel distance between item location 102 and locations 118, 120 of first user 110 and second user 112, respectively.

In a non-limiting example shown in FIG. 8, delivery vessel 124 is shown as a delivery van or truck, however, it is understood that delivery vessel 124 may include a transportation vehicle or machine that may deliver packages including, but not limited to, cars, trucks, trains, planes, bicycles, drones, and the like. Additionally, although one delivery vessel 124 is shown it is understood that more than one delivery vessel 124 may be utilized to deliver first item 104 to first user 110 at location 118, and second item 106 to second user 112 at location 120, as discussed herein.

Additionally in the non-limiting example, and as discussed herein with respect to FIG. 3, second item 106 may be delivered to second user 112 at location 120 along with first item 104 being delivered to first user 110 at location 118 as a result of first item 104 being located at a similar item location 102 as second item 106. That is, and with reference to FIG. 3, and identifying second item 106 associated with second user 112 may include determining an item location (e.g., location 102) of second item 106, (e.g., process P3-1). Once determined, item location 102 of first item 104 may be compared to item location 102 of second item 106 (e.g., process P10). In response to determining item location 102 of first item 104 is the same as item location 102 of second item 106 (e.g., “YES” at process P11), the location 120 of second user may be determined (e.g., process P4) and the processes for aiding in the delivery of first item 104 and second item 106 may continue as discussed herein (e.g., process P5-P7, P9).

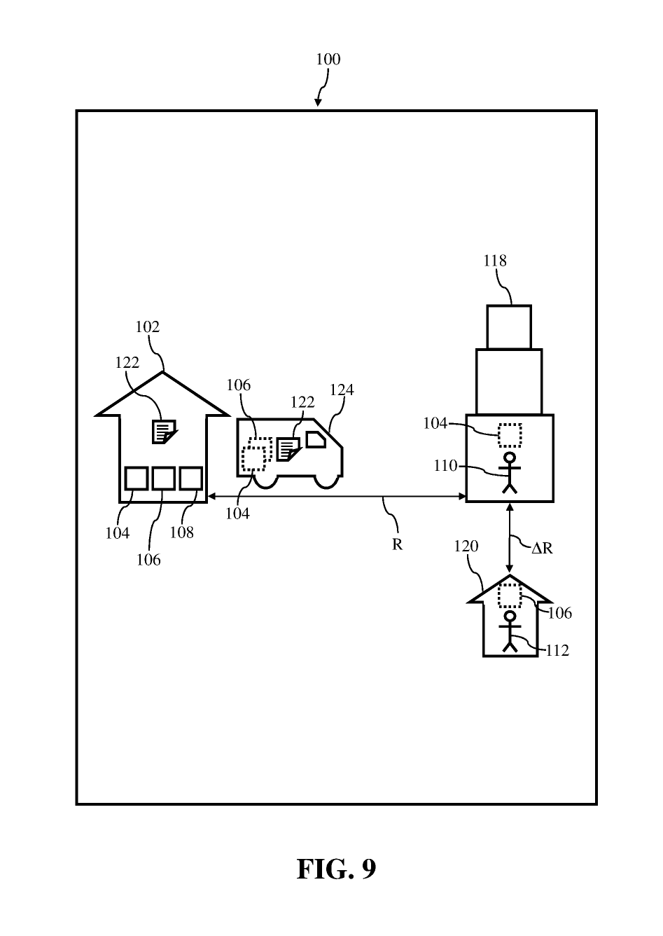

FIG. 9 shows another non-limiting example of environment 100. Distinct from FIG. 8, first user 110 and second user 112 in environment 100 shown in FIG. 9 may not be located in and/or share a common location 118, 120. Specifically, and as shown in FIG. 9, first user 110 may be located at location 118 (e.g., apartment building), and second user 112, associated with second item 106, may be located at location 120 (e.g., second user's home).

Performing the processes discussed herein to determine if second item 106 associated with second user 112 may be delivered with first item 104 associated with first user 110 as shown in environment 100 of FIG. 9 may be distinct from the non-limiting example discussed herein with respect to FIG. 8. For example, it may be determined that location 120 of second user 112 is distinct from location 118 of first user 110 (e.g., “NO” at process P6). As a result, it may be determined if location 118 of first user 110 is within a predetermined distance from location 120 of second user 112 (e.g., process P8). In response to determining location 120 of second user 112 is within the predetermined distance of location 118 of first user 110 (e.g., “YES” at process P8), delivery itinerary 122 may be updated as discussed herein (e.g., process P7). However, in response to determining location 120 of second user 112 is not within the predetermined distance of location 118 of first user 110 (e.g., “NO” at process P8), delivery itinerary 122 may be maintained for the future date and may only include first item 104 to be delivered to first user 110 at location 118 (e.g., process P9).

In the non-limiting example, the distance between location 118 of first user 110 and location 120 of second user 112 may be identified as “ΔR.” As discussed herein, the predetermined distance may be determined and/or defined by the supplier and/or deliverer of first item 104 and second item 106, and may include a distance (e.g., mileage) range or threshold and/or similarity threshold (e.g., predetermined percentage) in the delivery directions and/or a travel route between locations 118, 120.

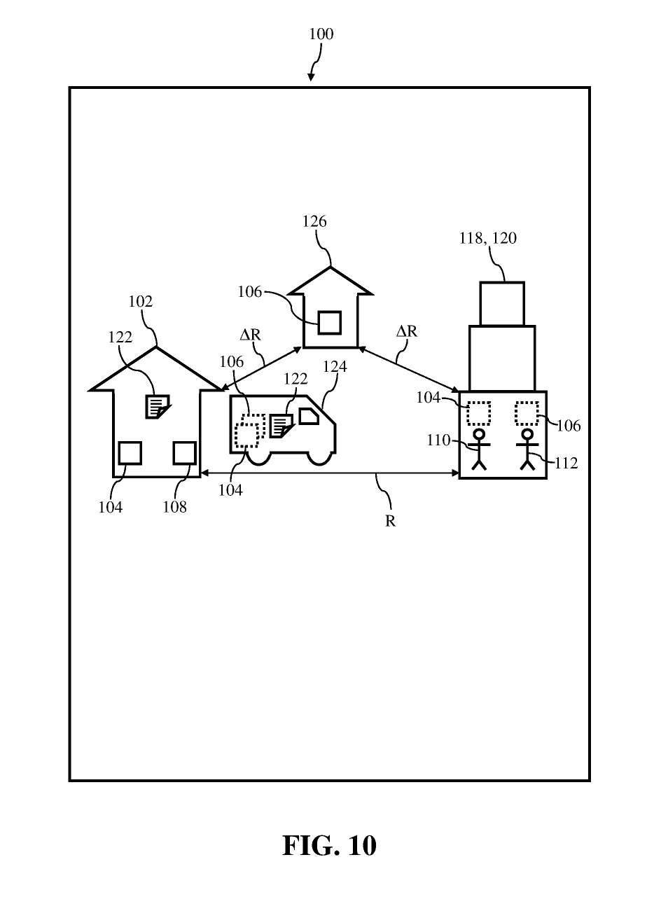

As shown FIG. 10, and distinct from FIGS. 8 and 9, first item 104 and second item 106 may not be located in and/or share a common item location 102, 126. Specifically, and as shown in the non-limiting example of environment 100 of FIG. 10, first item 114 may be located at item location 102, and second item 106, associated with second user 112, may be located at a distinct item location 126.

Performing the processes discussed herein to determine if second item 106 associated with second user 112 may be delivered with first item 104 associated with first user 110 as shown in environment 100 of FIG. 10 may be distinct from the non-limiting example discussed herein with respect to FIG. 8. For example, it may be determined that item location 126 of second item 106 is distinct from item location 102 of first item 104 (e.g., “NO” at process P11; FIG. 3). As a result, it may be determined if item location 102 of first item 104 is within a predetermined distance from item location 126 of second item 106 (e.g., process P12). In response to determining item location 126 of second item 106 is within the predetermined distance of item location 102 of first item 104 (e.g., “YES” at process P12), the location 120 of second user may be determined (e.g., process P4) and the processes for aiding in the delivery of first item 104 and second item 106 may continue as discussed herein (e.g., process P5-P7, P9). However, in response to determining item location 126 of second item 106 is not within the predetermined distance of item location 102 of first item 104 (e.g., “NO” at process P12), delivery itinerary 122 may be maintained for the future date and may only include first item 104 to be delivered to first user 110 at location 118 (e.g., process P9).

In the non-limiting example, the distance between item location 102 of first item 104 and item location 126 of second item 106 may be identified as “ΔR.” As discussed herein, the predetermined distance may be determined and/or defined by the supplier and/or deliverer of first item 104 and second item 106, and may include a distance (e.g., mileage) range or threshold and/or similarity threshold (e.g., predetermined percentage) in the delivery directions and/or a travel route between item locations 102, 126.

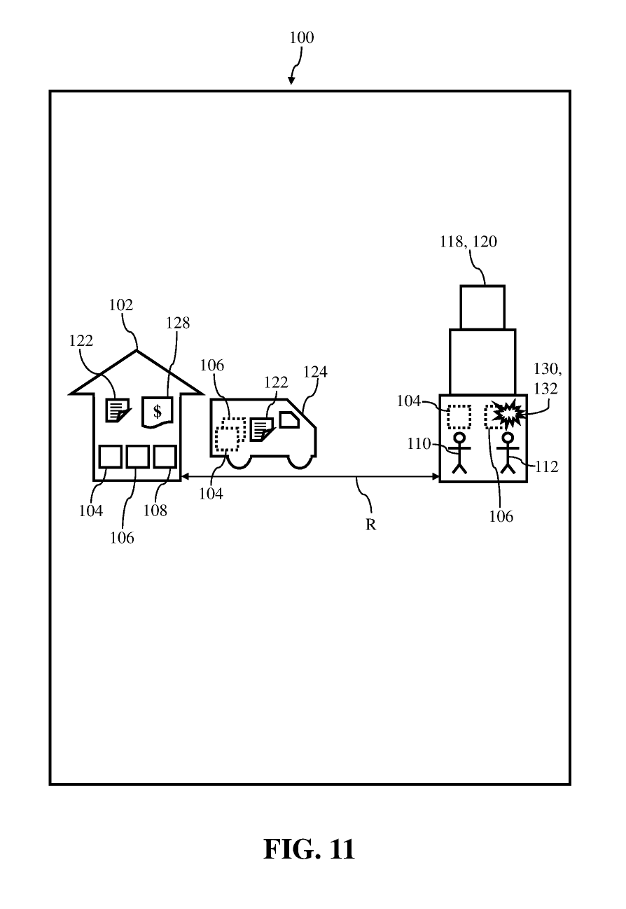

Turning to FIG. 11, performing the processes discussed herein to determine if second item 106 associated with second user 112 may be delivered with first item 104 associated with first user 110 as shown in environment 100 of FIG. 11 may include additional processes from the processes discussed herein with respect to FIGS. 8-10.

For example, identifying second item 106 associated with second user 112 may include determining if second user 112 purchased second item 106 (e.g., process P3-2). Determining if second user 112 purchased second item 106 may be achieved by analyzing a sales receipt and/or sale information 128 (hereafter, “sale information 128”) relating to the purchase of second item 106. In response to determining second user 112 purchased second item 106 (e.g., “YES” at process P13; FIG. 4), delivery itinerary 122 may be updated as discussed herein (e.g., process P7). Conversely, in response to determining second user 112 has not yet purchased second item 106 (e.g., “NO” at process P13), second user 112 may be prompted to purchase second item 106 within a predetermined time (e.g., process P14). In a non-limiting example shown in FIG. 11, second user 112 may be prompted by a notification 130 sent directly to second user 112 via an application, and/or an electronic device used by second user 112 to virtually view and/or purchase second item 106. Once prompted to purchase second item 106, it may again be determined if second user 112 purchased second item 106 (e.g., process P13) at the expiration of the predetermined time. In response to determining second user 112 purchased second item 106 before the expiration of the predetermined time (e.g., “YES” at process P13 (second inquiry)), delivery itinerary 122 may be updated as discussed herein (e.g., process P7). However, if it is determined second user 112 has not yet purchased second item 106 at the expiration of the predetermined time (e.g., “NO” at process P13), delivery itinerary 122 may be maintained for the future date and may only include first item 104 to be delivered to first user 110 at location 118 (e.g., process P9).

As discussed herein, the prompt and/or notification 130 may be sent to second user 112 using any suitable notification system, application, and/or process for providing a notification via an electronic device. For example, second user 112 may be prompted and/or sent notification 130 to purchase second item 106 by sending second user 112 an e-mail notification, a short message service (SMS) message, a multimedia messaging service (MMS) message, calling the second user, and the like. Additionally, and as discussed herein, the predetermined time may be a time defined by the supplier and/or deliverer of second item 106, and may be a time or date to ensure that if second user 112 purchases second item 106 within the predetermined time, second item 106 will be shipped/delivered to second user 112 when first item 104 is delivered to first user 110 on the future date.

Additionally, and in conjunction with the example discussed above, processes for determining if second item 106 associated with second user 112 may be delivered with first item 104 associated with first user 110 may also include determining if second user 112 purchased second item 106 prior to first user 110 purchasing first item 104 (e.g., process P15). In response to determining second user 112 did not purchase second item 106 prior to first user 110 purchasing first item 104 (e.g., “NO” at process P15), it may be determined if second user 112 purchased second item 106 at all (e.g., process P13), and the processes may follow as discussed herein (e.g., process P13, P14, P7, P9). Conversely, if it is determined that second user 112 did purchase second item 106 prior to first user 110 purchasing first item 104 (e.g., “YES” at process P15), a duration of time second user 112 is willing to wait for free shipping for delivery of second item 106 may be identified (e.g., process P16). Identifying the duration of time second user 112 is willing to wait for free shipping for delivery of second item 106 may be achieved by analyzing sale information 128 associated with the purchase of second item 106. As discussed herein, the duration of time second user 112 is willing to wait for free shipping for delivery of second item 106 may be defined by second user 112, for example, when second user 112 purchases second item 106.

Once the duration of time second user 112 is willing to wait for free shipping for delivery of second item 106 is identified (e.g., process P16), it may be determined if the duration of time second user 112 is willing to wait for free shipping for delivery of second item 106 has expired (e.g., process P17). In response to determining the duration of time second user 112 is willing to wait for free shipping for delivery of second item 106 has expired (e.g., “YES” at process P17), delivery itinerary 122 may be maintained as discussed herein (e.g., process P9). Conversely, if it is determined that the duration of time second user 112 is willing to wait for free shipping for delivery of second item 106 has not expired (e.g., “NO” at process P17), delivery itinerary 122 may be updated as discussed herein (e.g., process P7).’

In additional non-limiting examples, sale information 128 relating to the purchase of second item 106 by second user 112 may also include information relating to a reduced shipping cost. Continuing with the non-limiting processes discussed herein, in response to determining second user 112 purchased second item 106 (e.g., “YES” at process P13; FIG. 4), it may be determined if second user 112 paid the reduced shipping cost associated with the purchase and/or delivery of second item 106 (e.g., process P18; FIG. 6). As discussed herein, determining if second user 112 paid the reduced shipping cost may be achieved by analyzing sale information 128. In response to determining second user 112 purchased and/or paid the reduced shipping cost (e.g., “YES” at process P18), delivery itinerary 122 may be updated as discussed herein (e.g., process P7). Conversely, in response to determining second user 112 has not yet purchased and/or paid for the reduced shipping cost (e.g., “NO” at process P18), second user 112 may be prompted to purchase and/or pay for the reduced shipping cost within a predetermined time (e.g., process P19). In a non-limiting example shown in FIG. 11, second user 112 may be prompted by a distinct notification 132 sent directly to second user 112 via an application, and/or an electronic device used by second user 112 to virtually view and/or purchase second item 106. Once prompted to pay the reduced shipping cost, via distinct notification 132, it may again be determined if second user 112 paid the reduced shipping cost (e.g., process P18) at the expiration of the predetermined time. In response to determining second user 112 paid the reduced shipping cost before the expiration of the predetermined time (e.g., “YES” at process P18 (second inquiry)), delivery itinerary 122 may be updated as discussed herein (e.g., process P7). However, if it is determined second user 112 has not paid the reduced shipping cost at the expiration of the predetermined time (e.g., “NO” at process P18), delivery itinerary 122 may be maintained as discussed herein (e.g., process P9).

As discussed herein, and similar to notification 130, the prompt and/or distinct notification 132 may be sent to second user 112 using any suitable notification system, application, and/or process for providing a notification via an electronic device. For example, second user 112 may be prompted and/or sent notification 132 to pay the reduced shipping cost by sending second user 112 an e-mail notification, a short message service (SMS) message, a multimedia messaging service (MMS) message, calling the second user, and the like. Additionally, and as discussed herein, the predetermined time may be a time defined by the supplier and/or deliverer of second item 106, and may be a time or date to ensure that if second user 112 pays the reduced shipping cost within the predetermined time, second item 106 will be shipped/delivered to second user 112 when first item 104 is delivered to first user 110 on the future date.

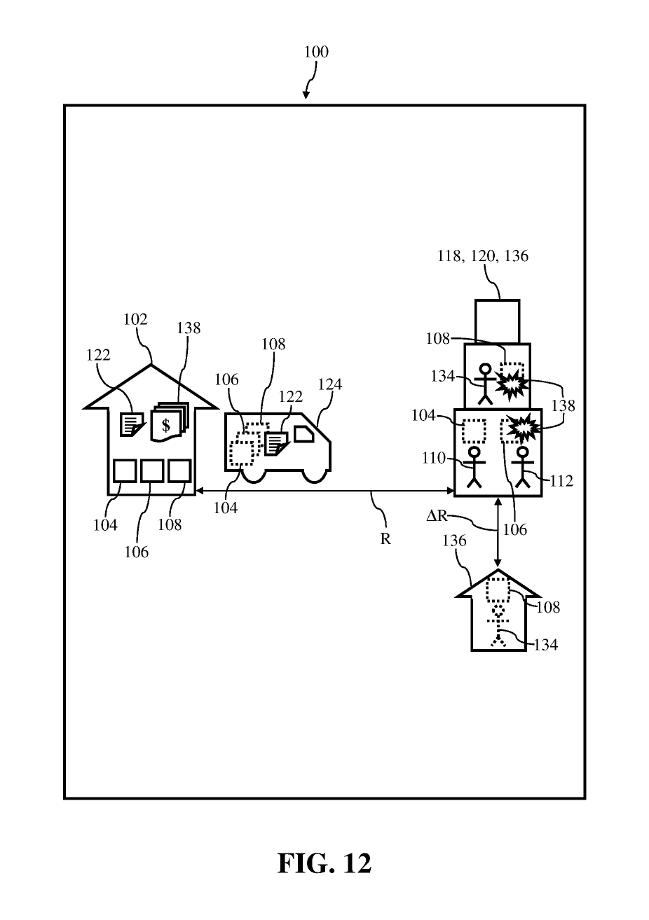

Turning to FIG. 12, another non-limiting example of environment 100 is shown. In the non-limiting example, environment 100 may also include a third user 134 distinct from first user 110 and second user 112, respectively. As shown in the non-limiting example of FIG. 12, third user 134 may be associated with third item 108 located at item location 102. Additionally, third user 134 may be located at location 136, which may be the same as location 118 of first user 110 and location 120 of second user 112, or may be distinct from locations 118, 120, as discussed herein. In this non-limiting example, processes discussed herein may be performed to determine if third item 108 associated with third user 134 may be delivered with first item 104 associated with first user 110, and second item 105 associated with second user 112. Furthermore, performing the processes for determining if third item 108 may be delivered with first item 104 and second 106 may include additional processes from the processes discussed herein with respect to FIGS. 8-11.

For example, and with reference to process P1-P7 of FIG. 1 and as previously discussed herein with respect to second user 112 in FIG. 8, third item 108 associated with third user 134 and located at item location 102, may be identified (e.g., process P20), and location 136 of third user 134 may be determined (e.g., process P21), and compared to location 118 of first user 110 (e.g., process P22). In response to determining location 136 of third user 134 is distinct from location 118 of first user 110 (e.g., “NO” at process P23) it may be determined if location 118 of first user 110 is within a predetermined distance from location 136 of third user 134 (e.g., process P24). If location 136 of third user 134 is not within the predetermined distance of location 118 of first user 110 (e.g., “NO” at process P24), delivery itinerary 122 may be maintained for the future date and may only include first item 104 to be delivered to first user 110 at location 118 (and second item 106 to be delivered to second user 112 at location 120, where applicable) (e.g., process P9).

However, if it is determined that location 136 of third user 134 is the same as location 118 of first user 110 (e.g., “YES” at process P23), or it is determined that location 136 of third user 134 is within the predetermined distance of location 118 of first user 110 (e.g., “YES” at process P24), it may be determined if second user 112 and/or third user 134 paid a crowd funded shipping cost 138 associated with the purchase and/or delivery of second item 106 and/or third item 108 (e.g., process P25; FIG. 7). As discussed herein, determining if second user 112 and/or third user 134 paid crowd funded shipping cost 138 may be achieved by analyzing sale information 128. In response to determining second user 112 and/or third user 134 purchased and/or paid crowd funded shipping cost 138 (e.g., “YES” at process P25), delivery itinerary 122 may be updated to include first item 104 to be delivered to first user 110 at location 118, second item 106 to be delivered to second user 112 at location 120, where applicable, and third item 108 to be delivered to third user 134 at location 136 (e.g., process P27).

Conversely, in response to determining second user 112 and/or third user 134 has not yet purchased and/or paid for crowd funded shipping cost 138 (e.g., “NO” at process P25), second user 112 and/or third user 134 may be prompted to purchase and/or pay for crowd funded shipping cost 138 within a predetermined time (e.g., process P26). In a non-limiting example shown in FIG. 12, second user 112 and/or third user 134 may be prompted by a distinct notification 140 sent directly to second user 112 and/or third user 134 via an application, and/or an electronic device used by second user 112 and/or third user 134 to virtually view and/or purchase their respective items 106, 108. Once prompted to pay crowd funded shipping cost 138, via distinct notification 140, it may again be determined if second user 112 and/or third user 134 paid crowd funded shipping cost 138 (e.g., process P25) at the expiration of the predetermined time. In response to determining second user 112 and/or third user 134 paid crowd funded shipping cost 138 before the expiration of the predetermined time (e.g., “YES” at process P25 (second inquiry)), delivery itinerary 122 may be updated as discussed herein (e.g., process P27). However, if it is determined second user 112 and/or third user 134 has not paid crowd funded shipping cost 138 at the expiration of the predetermined time (e.g., “NO” at process P25), delivery itinerary 122 may be maintained as discussed herein (e.g., process P9). In a non-limiting example, and as discussed herein, it does not matter who of second user 112 and/or third user 134 pays crowd funded shipping cost 138, so long as crowd funded shipping cost 140 is paid prior to the expiration of the predetermined time.

FIG. 13 depicts a schematic view of a computing environment or system 200 (hereafter, “computing system 200”), and the various components included within computing system 200. In the non-limiting example shown in FIG. 13, computing system 200 may include at least one computing device 202 that may be configured to aid in the delivery of items 104, 106, 108 to various users 110, 112, 134 by performing the processes P1-P27 discussed herein with respect to FIGS. 1-7. It is understood that similarly numbered and/or named components may function in a substantially similar fashion. Redundant explanation of these components has been omitted for clarity.

It is understood that computing device(s) 202 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 200 may include any type of computing device(s) 202 and for example includes at least one processor 204, storage component 206, input/output (I/O) component(s) 208 (including users electronic devices discussed herein), and a communications pathway 210. In general, processor(s) 204 execute program code which is at least partially fixed in storage component 206. While executing program code, processor(s) 204 can process data, which can result in reading and/or writing transformed data from/to storage component 206 and/or I/O component(s) 208 for further processing. The pathway 210 provides a communications link between each of the components in computing device(s) 202. I/O component 208 can comprise one or more human I/O devices, which enables user(s) 110, 112 to interact with computing device(s) 202. Computing device(s) 202 may also be implemented in a distributed manner such that different components reside in different physical locations.

Storage component 206 may also include modules, data and/or electronic information relating to various other aspects of computing system 200. Specifically, operational modules and/or data relating to identified item data 212, user location data 218, item location data 220, notification system data 222, item shipping cost data 224, free shipping item waiting data 226, and delivery itinerary data 228. The operational modules and/or data may include the required information and/or may allow computing system 200, and specifically computing device 202, to perform the processes discussed herein for aiding in the delivery of items to users 110, 112.

Computing system 200, and specifically computing device 202 of computing system 200, may also be in communication with an external storage component 230. External storage component 230 may be configured to store various modules, data and/or electronic information relating to various other aspects of computing system 200, similar to storage component 206 of computing device(s) 202. Additionally, external storage component 230 may be configured to share (e.g., send and receive) data and/or electronic information with computing device(s) 202 of Computing system 200. In the non-limiting example shown in FIG. 13, external storage component 230 may include any or all of the operational modules and/or data shown to be stored on storage component 206 (e.g., data 212-228). In a non-limiting example, external storage component 230 may be a cloud-based storage component or system.

In a non-limiting example shown in FIG. 13, computing system 200 including computing device(s) 202 may be the system of the supplier of the items associated with users 110, 112, where the supplier is also responsible for delivering the items 104, 106 to users 110, 112. In another non-limiting example, computing system 200 including computing device(s) 202 may be a system only for the supplier or deliverer of the items. In this non-limiting example, computing device(s) 202 may be in communication with and/or may be configured to share (e.g., send and receive) data and/or electronic information with a distinct deliverer/supplier computing system 232, and/or a computing device(s) (not shown) of the distinct computing system 232. Additionally in this non-limiting example, and similar to external storage component 230, distinct deliverer/supplier computing system 232 may include any or all of the operational modules and/or data shown to be stored on storage component 206 (e.g., data 212-228).

Furthermore, it is understood that computing device(s) 202 of computing system 200 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, and then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for aiding in a delivery of items to users, the method comprising:
determining a location of a first user, the first user having purchased a first item stored at a first item location;
generating a delivery itinerary for a future date, the delivery itinerary including the first item to be delivered to the first user at the location of the first user;
identifying a second item distinct from the first item, the second item associated with a second user, distinct from the first user;
determining a location of the second user;
comparing the location of the first user with the location of the second user; and
in response to determining the location of the first user is the same as the location of the second user, updating the delivery itinerary for the future date to include:
the first item to be delivered to the first user at the location of the first user, and
the second item to be delivered to the second user at the location of the second user.

2. The method of claim 1, further comprising:
in response to determining the location of the first user is distinct from the location of the second user, determining if the location of the first user is within a predetermined distance from the location of the second user; and
in response to determining the location of the first user is within the predetermined distance from the location of the second user, updating the delivery itinerary for the future date to include:
the first item to be delivered to the first user at the location of the first user, and
the second item to be delivered to the second user at the location of the second user.

3. The method of claim 1, wherein identifying the second item distinct from the first item further comprises determining an item location of the second item.

4. The method of claim 3, further comprising:
comparing the item location of the first item with the item location of the second item;
in response to determining the item location of the first item is the same as the item location of the second item, determining the location of the second user;
in response to determining the item location of the first item is distinct from the item location of the second item, determining if the item location of the second item is a predetermined distance from and between the item location of the first item and the first user; and
in response to determining the item location of the second item is within the predetermined distance from and between the item location of the first item and the first user, determining the location of the second user.

5. The method of claim 1, wherein identifying the second item distinct from the first item further comprises at least one of:
determining if the second user purchased the second item prior to the first user purchasing the first item,
determining if the second user added the second item to a wish list,
determining if the second user virtually viewed the second item a predetermined amount of times, or
determining if the second user one of:
added a distinct item to the wish list, or
virtually viewed the distinct item the predetermined amount of times,
wherein the distinct item includes similar item characteristics as the second item.

6. The method of claim 5, further comprising:
in response to determining the second user purchased the second item prior to the first user purchasing the first item, determining if a reduced shipping cost has been paid by the second user subsequent to determining the location of the first user is the same as the location of the second user; and
in response to determining the reduced shipping cost has been paid by the second user, updating the delivery itinerary for the future date to include:
the first item to be delivered to the first user at the location of the first user, and
the second item to be delivered to the second user at the location of the second user.

7. The method of claim 5, further comprising:
in response to at least one of determining the second user added the second item to the wish list or determining the second user virtually viewed the second item the predetermined amount of times, prompting the second user to purchase the second item within a predetermined time prior to updating the delivery itinerary for the future date.

8. The method of claim 5, further comprising:
in response to determining the second user purchased the second item prior to the first user purchasing the first item, identifying a duration of time the second user will wait for free shipping for delivery of the second item,
wherein the duration of time is defined by the second user; and
determining if the duration of time defined by the second user is exceeded.

9. The method of claim 1, further comprising:
in response to determining the location of the first user is the same as the location of the second user, identifying a third item distinct from the first item and second item, the third item associated with a third user, distinct from the first user and the second user;
determining the location of the third user;
comparing the location of the first user with the location of the third user;
in response to determining the location of the first user is the same as the location of the third user, determining if a crowd funded shipping cost has been paid by at least one of the second user, the third user, or at least one distinct user; and
in response to determining the crowd funded shipping cost has been paid, updating the delivery itinerary for the future date to include:
the first item to be delivered to the first user at the location of the first user,
the first second to be delivered to the second user at the location of the second user, and
the third item to be delivered to the third user at the location of the third user.

10. A computer program product stored on a computer readable storage medium, which when executed by a computing system, aids in a delivery of items to users, the program product comprising:
program code that determines a location of a first user, the first user having purchased a first item stored at a first item location;
program code that generates a delivery itinerary for a future date, the delivery itinerary including the first item to be delivered to the first user at the location of the first user;
program code that identifies a second item distinct from the first item, the second item associated with a second user, distinct from the first user;
program code that determines a location of the second user;
program code that compares the location of the first user with the location of the second user; and
program code that updates the delivery itinerary for the future date in response to the program code determining the location of the first user is the same as the location of the second user, the updated delivery itinerary for the future date including:
the first item to be delivered to the first user at the location of the first user, and
the second item to be delivered to the second user at the location of the second user.

11. The program product of claim 10, further comprising:
program code that determines if the location of the first user is within a predetermined distance from the location of the second user in response to the program code determining the location of the first user is distinct from the location of the second user; and
program code that program code that updates the delivery itinerary for the future date in response to the program code determining the location of the first user is within the predetermined distance from the location of the second user, the updated delivery itinerary for the future date including:
the first item to be delivered to the first user at the location of the first user, and
the second item to be delivered to the second user at the location of the second user.

12. The program product of claim 10, wherein the program code identifies the second item by:
determining an item location of the second item.

13. The program product of claim 12, further comprising:
program code that compares the item location of the first item with the item location of the second item;
program code that determines if the item location of the first item is the same as the item location of the second item; and
program code that determines if the item location of the second item is a predetermined distance from and between the item location of the first item and the first user.

14. The program product of claim 10, wherein the program code identifies the second item by:
determining if the second user purchased the second item prior to the first user purchasing the first item.

15. The program product of claim 14, further comprising:
program code that determines if a reduced shipping cost has been paid by the second user subsequent to determining the location of the first user is the same as the location of the second user and in response to determining the second user purchased the second item prior to the first user purchasing the first item; and
program code that updates the delivery itinerary for the future date in response to determining the reduced shipping cost has been paid by the second user, the updated delivery itinerary for the future date including:
the first item to be delivered to the first user at the location of the first user, and
the second item to be delivered to the second user at the location of the second user.

16. The program product of claim 10, further comprising:
program code that identifies a third item, distinct from the first item and second item, in response to the program code determining the location of the first user is the same as the location of the second user,
wherein the third item associated with a third user, distinct from the first user and the second user;
program code that determines the location of the third user;
program code that compares the location of the first user with the location of the third user;
program code that determines if a crowd funded shipping cost has been paid by at least one of the second user or the third user in response to the program code determining the location of the first user is the same as the location of the third user; and
program code that updates the delivery itinerary for the future date in response to the program code determining the crowd funded shipping cost has been paid, the updated delivery itinerary for the future date including:
the first item to be delivered to the first user at the location of the first user,
the first second to be delivered to the second user at the location of the second user, and
the third item to be delivered to the third user at the location of the third user.

17. A computing system for aiding in a delivery of items to users, the computing system comprising:
an identified item data module that:
identifies a first item purchased by a first user; and
identifies a second item associated with a second user;
a user location data module that:
determines a location of the first user;
determines a location of the second user; and
compares the location of the first user with the location of the second user; and
determines if the location of the first user is the same as the location of the second user; and
a delivery itinerary data module that:
generates a delivery itinerary for a future data, the generated delivery itinerary including the first item to be delivered to the first user at the location of the first user; and
updates the delivery itinerary for the future date in response to the user location data module determining that the location of the first user is the same as the location of the second user, the updated delivery itinerary including:
the first item to be delivered to the first user at the location of the first user, and
the second item to be delivered to the second user at the location of the second user.

18. The computing system of claim 17, wherein the user location data module:
determines if the location of the first user is within a predetermined distance from the location of the second user in response to determining the location of the first user is distinct from the location of the second user; and
updates the delivery itinerary for the future date in response to determining the location of the first user is within the predetermined distance from the location of the second user, the updated delivery itinerary including:
the first item to be delivered to the first user at the location of the first user, and
the second item to be delivered to the second user at the location of the second user.

19. The computing system of claim 17, wherein the identified item data module identifies the second item associated with the second user by at least one of:
determining if the second user purchased the second item prior to the first user purchasing the first item,
determining if the second user added the second item to a wish list,
determining if the second user virtually viewed the second item a predetermined amount of times, or
determining if the second user one of:
added a distinct item to the wish list, or
virtually viewed the distinct item the predetermined amount of times,
wherein the distinct item includes similar item characteristics as the second item.

20. The computing system of claim 19, further comprising:
an item shipping cost data module that:
determines if a reduced shipping cost has been paid by the second user subsequent to:
the user location data module determining the location of the first user is the same as the location of the second user; and
the identified item data module determining the second user purchased the second item prior to the first user purchasing the first item; and
wherein the delivery itinerary data module updates the delivery itinerary for the future date in response to the item shipping cost data module determining the reduced shipping cost has been paid by the second user, the updated delivery itinerary including:
the first item to be delivered to the first user at the location of the first user, and
the second item to be delivered to the second user at the location of the second user.
